(19) United States
(12) Patent Application Publication
(10) Pub. No.: US 2024/0273412 A1
(43) Pub. Date: Aug. 15, 2024

(54) UNLEARNABLE TASKS IN MACHINE LEARNING

(71) Applicant: EATON INTELLIGENT POWER LIMITED, Dublin 4 (IE)

(72) Inventors: Neil BROCKETT, Ballybunion (IE); Catriona CLARKE, Kildare (IE); Michele BERLINGERIO, Castlenock (IE)

(21) Appl. No.: 18/566,489

(22) PCT Filed: Jun. 2, 2021
(86) PCT No.: PCT/EP2021/064869

§ 371 Date: Dec. 1, 2023

(51) Int. Cl. G06N 20/00

(52) U.S. Cl. CPC G06N 20/00

(57) ABSTRACT

A computer-implemented method of determining whether a task can be completed by machine learning is described. The method comprising the following steps. First of all, test data for the task is obtained. Using the test data, a determination is made for a plurality of machine learning algorithms whether any of the machine learning algorithms is able to perform the task to meet a performance threshold. If none of the machine learning algorithms performs the task to the performance threshold, a set of failure modes are identified, and a determination is made for each failure mode of a likelihood of that failure mode causing failure to meet the performance threshold. From this, an output is provided indicating relative likelihoods of each failure mode of the set causing failure to meet the performance threshold. A computer system suitable for performing the method is also described.

### TECHNICAL FIELD

The disclosure relates to unlearnable tasks in machine learning. In particular, the disclosure relates to methods and apparatus adapted to identify and address situations in which a machine learning system is unable to learn a task.

### BACKGROUND

Machine learning is an increasingly common technique for prediction of events and performance of complex tasks—it involves the use of computer algorithms that improve automatically through experience. Machine learning algorithms build a mathematical model from sample data, known as “training data”, and then use this mathematical model to make predictions or decisions. Machine learning algorithms are used in a wide variety of applications where it is difficult or infeasible to develop conventional algorithms to perform the needed tasks.

While machine learning provides a way to classify and predict (or prevent) events and their characteristics, it will not always succeed. In “Learnability Can be Undecidable”, Nature Machine Intelligence 1, 44-48 (2019), Ben-David et al established that it is not even provable whether certain machine learning tasks can be learned at all. Machine learning may fail due to a number of factors: missing data, data quality, poor algorithmic performance, and so on. Failure may result from a single factor, or a combination.

In cases of machine learning failure, skilled human intervention is typically required. This is a barrier to effective automation of complex tasks. It would be desirable to manage machine learning failure in such a way that this barrier is removed.

### SUMMARY OF DISCLOSURE

In a first aspect, the disclosure provides a computer-implemented method of determining whether a task can be completed by machine learning, the method comprising: obtaining test data for the task; using the test data, determining for a plurality of machine learning algorithms whether any of the machine learning algorithms is able to perform the task to meet a performance threshold; if none of the machine learning algorithms performs the task to the performance threshold, identifying a set of failure modes and determining for each failure mode a likelihood of that failure mode causing failure to meet the performance threshold; and providing an output indicating relative likelihoods of each failure mode of the set causing failure to meet the performance threshold.

This approach enables an effective determination not only of whether machine learning is able to complete the task in its present form, but also where it is not, providing an indication of the most likely reason for failure. Typically, if one of the machine learning algorithms performs the task to the performance threshold, that machine learning algorithm will be selected to perform the task. By using this approach, it should be possible to use that algorithm without further optimisation (such as hyperparameter tuning)—it may be provided as an output with suitable hyperparameters from the determination that it was able to perform the task.

If, however, no algorithm is suitable, the identification of a most likely reason for failure provides an effective basis for remediation, and so may allow this to take place without expert analysis.

In embodiments, after obtaining the test data, it may be prepared so that it is suitable for use by each of the machine learning algorithms of the plurality of machine learning algorithms.

In embodiments, the step of determining for a machine learning algorithm determines training and testing the machine learning algorithm at least once to determine whether an instance of the trained machine learning algorithm meets the performance threshold. The step of determining for a machine learning algorithm may comprise a k-fold cross validation, wherein training and testing the machine learning algorithm occurs k times for k different divisions of the test data into training data and evaluation data to provide k instances of the trained machine learning algorithm. This process of k-fold cross validation may further comprise tuning the hyperparameters of the machine learning algorithm. For the k-fold cross validation, results for each of the k instances of the trained machine learning algorithm may be averaged to determine whether the performance threshold is met.

The performance threshold may be—but is not limited to—one of the following: an accuracy metric, a precision metric, a recall metric, a F1 score metric, a detection rate metric and a false alarm rate metric. The potential failure modes may comprise one or more of insufficient data, data imbalance and missing data.

The step of determining for each failure mode a likelihood of that failure mode causing failure to meet the performance threshold may comprise generating a plurality of data sets for each failure mode. This generation of data sets for each failure mode may be varied for each data set to provide a different likelihood of that failure mode applying to each data set. The step of determining for each failure mode a likelihood of that failure mode causing failure to meet the performance threshold may comprise, for each failure mode, of determining how each data set for that failure mode performs for that machine learning algorithm and comparing the performance of the test data to each of the data sets. Comparing the performance of the test data to each of the data sets may comprise establishing where the test data lies on a linear interpolation between a least effective data set and a threshold data set that substantially performs at the performance threshold. The position of the test data on the linear interpolation may be equated to a likelihood that the associated failure mode is responsible for machine learning failure.

The output may be a listing of the failure modes in an order of likelihood that each failure mode is responsible for machine learning failure.

In a second aspect, the disclosure provides a computing system adapted to manage machine learning of a task, the computing system comprising a processor and a memory establishing a computing environment comprising the following functional elements: a data establishment element adapted to obtain test data for the task; a machine learning test element adapted to use the test data to determine for a plurality of machine learning algorithms whether any of the machine learning algorithms is able to perform the task to meet a performance threshold; a failure mode determining element adapted, if none of the machine learning algorithms performs the task to the performance threshold, to identifying a set of failure modes and to determine for each failure mode a likelihood of that failure mode causing failure to meet the performance threshold; and an output providing element adapted to indicate relative likelihoods of each failure mode of the set causing failure to meet the performance threshold.

The machine learning test element may be adapted such that if one of the machine learning algorithms performs the task to the performance threshold, the output providing element indicates that that that machine learning algorithm is able to perform the task.

The data establishment element may be adapted such that it follows obtaining the test data by preparing the test data so that it is suitable for use by each of the machine learning algorithms of the plurality of machine learning algorithms.

The machine learning test element may be adapted for training and testing the machine learning algorithm at least once to determine whether an instance of the trained machine learning algorithm meets the performance threshold. If so, the machine learning test element may be adapted to use a k-fold cross validation of each machine learning algorithm using the test data, wherein training and testing the machine learning algorithm occurs k times for k different divisions of the test data into training data and evaluation data to provide k instances of the trained machine learning algorithm, and wherein results for each of the k instances of the trained machine learning algorithm are averaged to determine whether the performance threshold is met.

The failure mode determining element may be adapted such that determining for each failure mode a likelihood of that failure mode causing failure to meet the performance threshold comprises generating a plurality of data sets for each failure mode. It may also then be adapted such that the generation of data sets for each failure mode is varied for each data set to provide a different likelihood of that failure mode applying to each data set. The failure mode determining element may then be adapted to, for each failure mode, determine how each data set for that failure mode performs for that machine learning algorithm and to compare the performance of the test data to each of the data sets. This failure mode determining element may be adapted to compare the performance of the test data to each of the data sets by establishing where the test data lies on a linear interpolation between a least effective data set and a threshold data set that substantially performs at the performance threshold, wherein the position of the test data on the linear interpolation is equated to a likelihood that the associated failure mode is responsible for machine learning failure.

The output providing element may be adapted to provide a listing of the failure modes in an order of likelihood that each failure mode is responsible for machine learning failure. This output providing element may also be adapted to provide a remediation strategy for providing a machine learnable data set for the task.

### BRIEF DESCRIPTION OF FIGURES

Embodiments of the disclosure will now be described, by way of example, with reference to the following figures, in which:

FIG. 1 provides a functional illustration of a system including apparatus adapted to perform embodiments of the disclosure;

FIG. 2 is a schematic diagram of computing apparatus adapted to perform embodiments of the disclosure;

FIG. 3 shows a method according to an embodiment of the disclosure expressed in general terms;

FIG. 4 shows attempted performance of a task by a machine learning system according to an embodiment of the disclosure; and

FIG. 5 shows analysis of machine learning task failure according to an embodiment of the disclosure.

### DETAILED DESCRIPTION

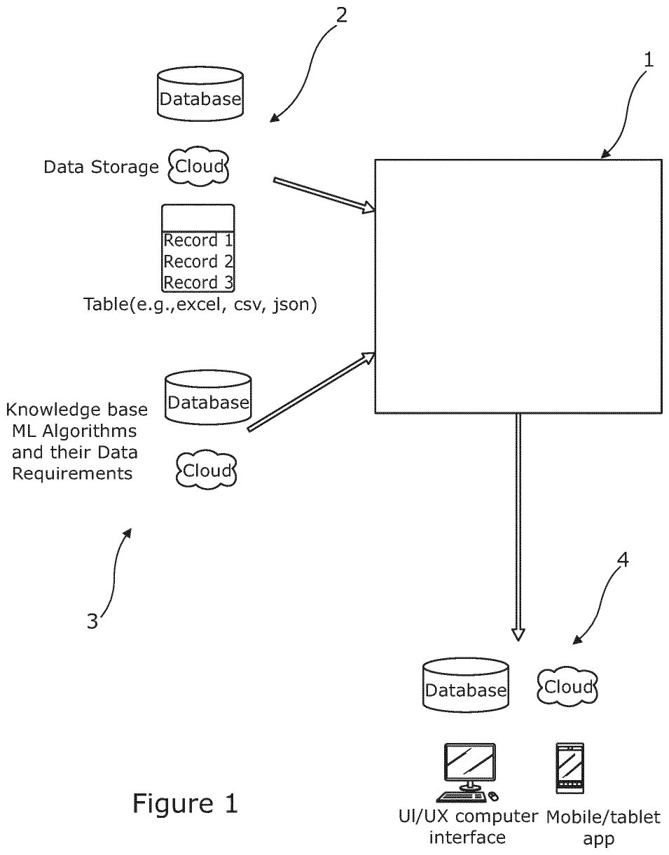

In embodiments, the disclosure provides methods and apparatus for evaluating whether machine learning can address a particular task, and for identifying the most likely cause of failure where machine learning is found to be ineffective with the data available. A general context in which embodiments of the disclosure can be deployed is shown in FIG. 1. A computer system 1 adapted for machine learning has access to two types of data resource—a test data resource 2 and a machine learning data resource 3. The test data resource 2 (which can comprise one or more of databases and tables within the computer system 1 or accessible to it over networks, or data from the cloud) contains data used for training and testing the machine learning system—this is typically data obtained from real world observation or measurement. The machine learning resource 3—which may comprise a similar set of local or remote sources—provides access to an extended range of machine learning techniques in algorithm form. This may comprise essentially any machine learning technique appropriate to the problem under consideration. The output of the computer system 1 may be a machine learning algorithm choice, but it may also be an identification that machine learning has failed with an indication of the most likely cause of failure, as will be discussed further below. The output is provided to an appropriate external interface 4 for provision of mitigating actions—as shown in FIG. 1, exemplary outputs are a UX/UI Interface, a mobile/tablet application, a database and a cloud location.

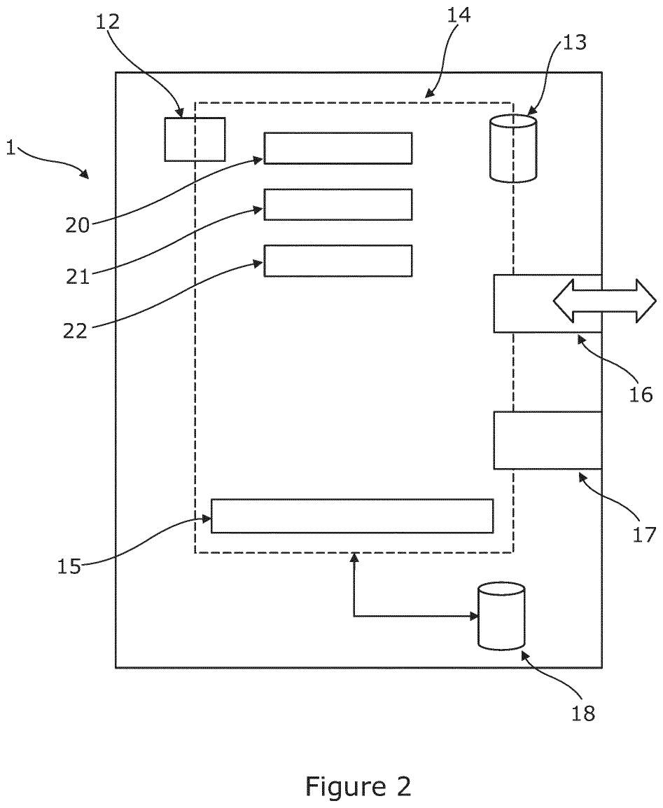

An exemplary computer system 1 is shown in more detail in FIG. 2. This may be implemented as a server, a personal computer, or as any other appropriate computing device or system of interacting computing devices. Processor 12 and memory 13 combine to define a computing environment 14 under the control of an operating system 15. The machine learning management functionality in accordance with embodiments of the disclosure is provided by three linked elements, here shown as separate applications: a data management application 21, an algorithm filtering application 22, and a failure cause assessment application 23. While shown here as separate applications, these may be provided by different mechanisms—for example, they may be provided as separate modules of a single application.

The computer system 1 interacts with other system elements, such as the test data resource 2, the machine learning resource 3 and the external interface 4, through a networking interface 16. The computer system will generally also have a user interface 17 to allow direct interaction between a user and the computer system 1, for example for management of the computer system 1 itself or for control or configuration of the applications. Some resources needed by the computer system 1—such as some or all of the test data resource 2 or the machine learning resource 3—may be held locally rather than remotely—additional memory 18 is shown as a resource which may be used by the computer system 1 for this purpose.

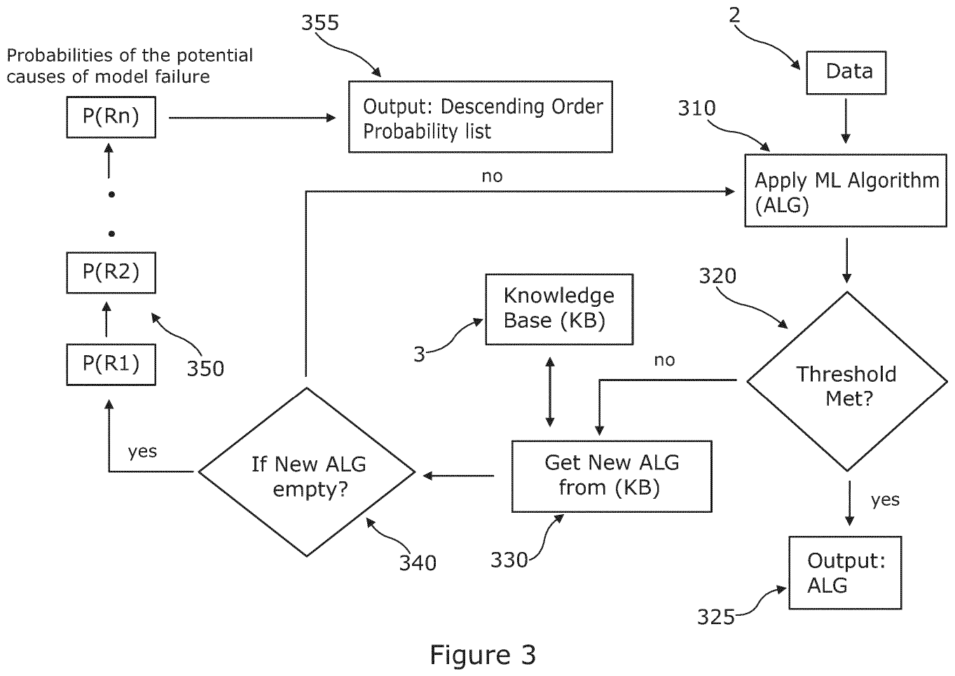

An embodiment of the disclosure will now be shown in more detail with reference to FIGS. 3 to 5. FIG. 3 shows the functional architecture of the embodiment in general terms. Data is obtained from the test data resource 2, and some of this data is used as training data to train 310 a machine learning algorithm. The trained algorithm is tested 320—using another part of the data—to see whether it meets a performance threshold. If the threshold is met, this algorithm is output 325 as an effective machine learning algorithm, and the process stops. However, if the threshold is not met, a new algorithm (or possibly in some cases a new version of another algorithm, perhaps with a very different hyperparameter set) is obtained 330 from the machine learning resource 3. The steps of training 310, testing 320 and new algorithm selection 330 continue until a successful algorithm is found 325 or until there are no algorithms remaining 340. If there are no algorithms remaining, the process continues by establishing 350 the probability of each failure mode, and outputting 355 the failure modes in order of likelihood. From this output, it will typically be straightforward to identify the best remediating process.

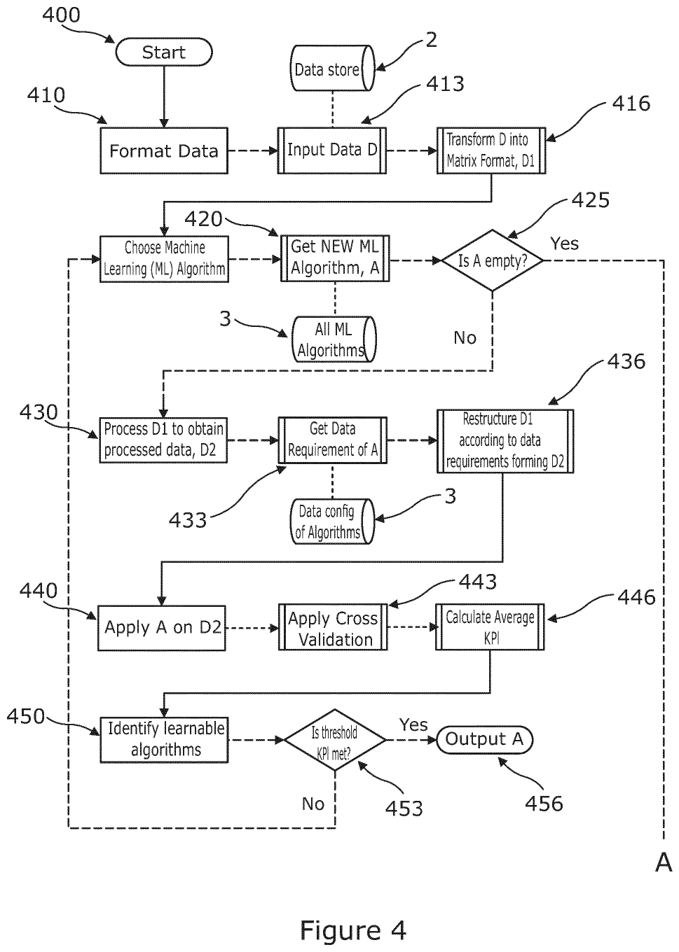

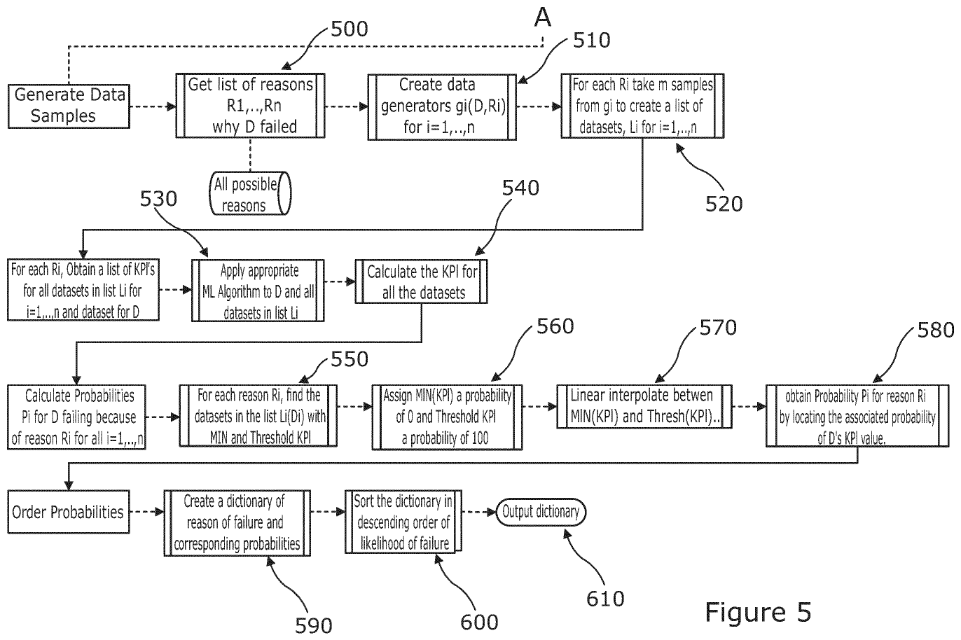

This process will be described in more detail with reference to FIGS. 4 and 5—FIG. 4 describes the algorithm evaluation process in more detail, whereas FIG. 5 addresses the evaluation of the different failure modes.

The embodiment described is essentially a nine-step process—the first five steps are shown in FIG. 4. On starting 400, the first step is to format data D 410 obtained 413 from data resource 2. The input data is cleaned as necessary and assembled 416 into matrix form D1 from which data can be extracted for training and testing machine learning algorithms. A first algorithm A is then selected 420 from the machine learning resource 3. The machine learning algorithms could be provided in any order, or the selection process may start with preferred choices. The machine learning algorithms will be provided from the machine learning resource 3 with a set of associated hyperparameters for use in their operation.

The data formatting requirements of the current machine learning algorithm A may require reformatting 430 of the input data. Data requirements will similarly be obtainable 433 from the machine learning resource 3 and can be used to reformat 436 the matrix form data D1 into the reformatted data D2 required by the machine learning algorithm A currently under evaluation.

The current machine learning algorithm A can then be evaluated 440 using data D2. This can be done using a K-fold cross-validation process 443. To do this, data is split into training and validation test sets, a training process is performed using training data and a validation process is performed using validation data to determine a key performance indicator (KPI), such as accuracy, for the validation process. Accuracy is one of a number of possible KPIs-precision, recall, F1 score, detection rate, false alarm rate are all possibilities. However, only one KPI will be chosen for the thresholding. This whole process is carried out K times using a different division of the data, with the KPI determined for each of the K times. This division could be random sampling or stratified sampling—any sampling technique that is exhaustive and which produces two disjoint sets can be applied. An average KPI is then obtained 446, which is considered to be the KPI for the algorithm A currently under test. This may be more than a simple application of the algorithm—hyperparameter tuning may be carried out in combination with the cross-validation process using a discretized hyperparameter space, as is often done with techniques such as grid search and random search.

A threshold KPI for the task will have previously been determined—for example, a level of accuracy determined as sufficient for an event recognition task. Determination 450 of whether current machine learning algorithm A is acceptable for use involves determining 453 whether the KPI established for algorithm A exceeds the predetermined threshold—if so, it is output 456 as suitable for use—or if it does not, in which case the process loops back to select a further machine learning algorithm. This continues until there are no further machine learning algorithms to select. If an algorithm is selected as suitable for use, it should not be necessary for there to be retraining and hyperparameter optimisation for the algorithm—however, the results of the KPI and hyperparameters from the cross-validation step may then be provided as output in addition to the algorithm itself.

If this process has completed 425 without the identification of a successful machine learning algorithm, the process continues with the failure evaluation process shown in more detail in FIG. 5.

Once it has been established that no algorithm has met the KPI, the data D is determined to be “unlearnable”. The next step is to establish why the data D is unlearnable, which requires evaluation of the possible causes of failure, which begins with a process of data generation. A list of possible reasons R1, . . . , Rn is established 500 from a relevant knowledge base of reasons for data failure—this may be information derived from the machine learning resource 3, for example. For each reason Ri, synthetic data generators are created 510 and a list of datasets Li is generated 520 using the appropriate synthetic data generator, where
Li=[bi1, bi2, . . . , bim], with bij=the jth dataset generated for reason Ri, to test the likelihood of that reason being the root cause of the data failure.

The data generation mechanism will vary depending on the cause of failure. Different causes may require more data, more relevant data or more diverse data. In general, the data generation process needs to create datasets which are better and datasets which are worse. For example, if the cause is insufficient data, the generator would synthetically generate additional data from the real data available and also provide data sets with less data. If data imbalance is the cause under evaluation, the generator will again synthetically generate data but will also oversample unbalanced classes by increasingly higher factors to create more balanced data sets and take the reverse approach to make less balanced ones. If missing data is the cause under evaluation, the generator will create likely values to fill in missing values for an improved set or remove more data for a worse one.

The following steps are carried out for each reason Ri and are used to determine the likelihood that reason Ri was the cause of failure. The first of these steps is to evaluate 520 the datasets in list Li. This is done by applying 530 a suitable machine learning algorithm (or algorithms) to all of the datasets in list Li and to dataset D for determining a KPI. This algorithm may in principle be randomly chosen, or specific choices may be made for different reasons Ri—for example a technique such as Random Forest may deal with imbalanced data more effectively than Logistic Regression. One possibility is to use a list of models and to calculate an average KPI for the dataset across the range of models. For each dataset bij and the original dataset D, a KPI is calculated and stored 540 (this may be, but need not be, the KPI used for thresholding earlier). The result of this is a set of KPI values for the datasets in list Li along with a KPI value for original dataset D. These can then be used to determine the likelihood that Ri is the reason for failure. To establish this, the minimum KPI value associated with a dataset in the list Li is obtained 550 (the minimum KPI from the original dataset D could also be used), along with a threshold KPI value associated with a dataset in the list Li. “Threshold KPI” in this context indicates a dataset that would just have passed the original threshold for selection in the earlier evaluation process—datasets that would have comfortably passed this threshold need not be considered further in this process. This “minimum KPI” and “threshold KPI” are assigned 560 probabilities of 100% and 0% respectively associated with being the cause of data failure. A line is drawn 570 between these two points, which represent the MIN and MAX values that the original KPI could have obtained and still failed. The probability of reason Ri being the cause of data failure is then obtained by linear interpolation, specifically by locating 580 the associated probability of dataset D's KPI on the line between these two points.

In this way, a probability Pi for each reason for failure Ri is established that this cause would lead to failure for dataset D. These probabilities can now be ordered for output, specifically by creating a dictionary 590 of all the reasons and their associated probabilities. This dictionary can be ordered 600 according so that each reason Ri appears in the dictionary in descending order of the likelihood Pi of being the cause of failure. This result can then be output 610 for use.

The use of the output of the embodiment of the disclosure is not discussed in detail here, save to note that the output is now in a form that can be addressed either by a normal user (rather than a data science expert) or by an automated process. A most probable cause of failure is identified, along with a likelihood of failure based on that cause. Once the specific cause of failure is identified, it will normally be well understood how to address it. There will normally be a best approach to take for an identified cause of failure, and the amount of change needed is likely to be broadly indicated by how far data set D failed to meet the threshold KPI. This should in most cases be sufficient to determine a new data capture or sampling strategy to provide a data set effective for machine learning.

In some cases, it may be necessary to reconsider expectations rather than change strategy—for example, there will be cases in which imbalanced data is to be expected (such as in loan default, for example—you will only have a few people that default and the majority will not, so you cannot really change how data is captured). However for other reasons, such as missing/insufficient data, there may be a ready solution—for example, for survey data, results could lead to reformatting the wording of questions in the survey (such as by only including questions with several options rather than allowing free form input). If data is received from sensors, resampling of sensor data could also solve issues with missing data.

This approach can be employed in essentially any environment using machine learning, particularly where a choice of different machine learning techniques is appropriate. It could be used in an API any general-purpose Artificial Intelligence/Machine Learning cloud platform or product. It could be applied directly in specific domains—one example will be discussed below.

Predictive maintenance is generally challenging, as machines may have a range of failure modes. This can be a particular issue in hydraulics, where failures can lead to significant downtime for critical machinery (for example in oil or gas production). It would be desirable to avoid as much unplanned downtime for such machinery as possible.

Machine learning has the potential to address problems of this type, and there are now a wide variety of machine learning techniques available. The greater challenge may be in obtaining sufficient data. or sufficiently good data, to enable the machine learning techniques to work effectively. For example, the wish may be to establish a predictive maintenance strategy for a particular machine type where the available data is derived from a limited number of machines or a limited time period.

Using an embodiment of the present disclosure, all applicable machine learning techniques can be tried, and it can be determined whether any of them meets the required prediction accuracy for failures necessary for an effective predictive maintenance strategy. If this accuracy is not met, the potential causes for failure will be considered, and the likelihood of failure for each assessed—the output being a listing of potential causes of failure in reverse likelihood order. This process can establish a most promising machine learning technique, and also its most likely reason for failure—thus leading to a clear path for reaching a successful implementation. For example, in this situation it may be found that Frequent Sequence Mining was the most robust technique, but that the most likely failure mode was data quantity (over data annotation and data imbalance)—there was simply not enough data available to allow prediction to reach the required accuracy. The likelihood of failure also gives some indication of how much further data may be required. The same principle would apply to other failure modes—for example, if it were found that insufficiently balanced data was the most likely cause, then this could be corrected by taking steps to provide balanced data (which may involve, for example, data over a more extended period or derived from a broader range of situations). This is an output that could be used by a human, but could also be used by an automated machine learning machine (such as Google AutoML, IBM Watson Analytics, Azure ML/AI) to take further steps to address the deficiency in the input data—as the action required to address a particular failure mode is known, then this turns a problem that previously required expert judgement into one that can be performed by carrying out an identified step in a data science toolkit.

As noted above, embodiments of the present disclosure can be used as part of a general-purpose machine learning toolkit, and can be applied directly to specific problems, such as predictive maintenance. However, the skilled person will appreciate that many further embodiments are possible within the spirit and scope of the disclosure set out here.

1. A computer-implemented method of determining whether a task can be completed by machine learning, the method comprising:
obtaining test data for the task;
using the test data; for determining, for a plurality of machine learning algorithms, whether any of the machine learning algorithms is able to perform the task to meet a performance threshold;
if none of the machine learning algorithms performs the task to the performance threshold, identifying a set of failure modes and determining for each failure mode a likelihood of that failure mode causing failure to meet the performance threshold; and
providing an output indicating relative likelihoods of each failure mode of the set causing failure to meet the performance threshold.

2. The method of claim 1, further comprising if one of the machine learning algorithms performs the task to the performance threshold, selecting that machine learning algorithm to perform the task.

3. The method of claim 1, wherein after obtaining the test data, the method further comprises preparing the test data so that it is suitable for use by each of the machine learning algorithms of the plurality of machine learning algorithms.

4. The method of claim 1, wherein the step of determining for a machine learning algorithm determines training and testing the machine learning algorithm at least once to determine whether an instance of the trained machine learning algorithm meets the performance threshold.

5. The method of claim 4, wherein the step of determining for a machine learning algorithm comprises a k-fold cross validation, wherein training and testing the machine learning algorithm occurs k times for k different divisions of the test data into training data and evaluation data to provide k instances of the trained machine learning algorithm, wherein for the k-fold cross validation, results for each of the k instances of the trained machine learning algorithm are averaged to determine whether the performance threshold is met.

5-9. (canceled)

10. The method of claim 1, wherein the step of determining for each failure mode a likelihood of that failure mode causing failure to meet the performance threshold comprises generating a plurality of data sets for each failure mode.

11. The method of claim 10, wherein the generation of data sets for each failure mode is varied for each data set to provide a different likelihood of that failure mode applying to each data set.

12. The method of claim 10 or claim 11, wherein the step of determining for each failure mode a likelihood of that failure mode causing failure to meet the performance threshold comprises, for each failure mode, of determining how each data set for that failure mode performs for that machine learning algorithm and comparing the performance of the test data to each of the data sets.

13. The method of claim 12, wherein comparing the performance of the test data to each of the data sets comprises establishing where the test data lies on a linear interpolation between a least effective data set and a threshold data set that substantially performs at the performance threshold wherein the position of the test data on the linear interpolation is equated to a likelihood that the associated failure mode is responsible for machine learning failure.

14. (canceled)

15. The method of claim 1, wherein the output is a listing of the failure modes in an order of likelihood that each failure mode is responsible for machine learning failure.

16. A computing system adapted to manage machine learning of a task, the computing system comprising a processor and a memory establishing a computing environment comprising the following functional elements:
a data establishment element adapted to obtain test data for the task;
a machine learning test element adapted to use the test data to determine for a plurality of machine learning algorithms whether any of the machine learning algorithms is able to perform the task to meet a performance threshold;
a failure mode determining element adapted, if none of the machine learning algorithms performs the task to the performance threshold, to identifying a set of failure modes and to determine for each failure mode a likelihood of that failure mode causing failure to meet the performance threshold; and
an output providing element adapted to indicate relative likelihoods of each failure mode of the set causing failure to meet the performance threshold.

17. The computing system of claim 16, wherein the machine learning test element is adapted such that if one of the machine learning algorithms performs the task to the performance threshold, the output providing element indicates that the machine learning algorithm is able to perform the task.

18. The computing system of claim 16, wherein the data establishment element is adapted such that it follows obtaining the test data by preparing the test data so that it is suitable for use by each of the machine learning algorithms of the plurality of machine learning algorithms.

19. The computing system of claim 16, wherein the machine learning test element is adapted for training and testing the machine learning algorithm at least once to determine whether an instance of the trained machine learning algorithm meets the performance threshold.

20. The computing system of claim 19, wherein the machine learning test element is adapted to use a k-fold cross validation of each machine learning algorithm using the test data, wherein training and testing the machine learning algorithm occurs k times for k different divisions of the test data into training data and evaluation data to provide k instances of the trained machine learning algorithm, and wherein results for each of the k instances of the trained machine learning algorithm are averaged to determine whether the performance threshold is met.

21. The computing system of claim 16, wherein the failure mode determining element is adapted such that determining for each failure mode a likelihood of that failure mode causing failure to meet the performance threshold comprises generating a plurality of data sets for each failure mode.

22. The computing system of claim 21, wherein the failure mode determining element is adapted such that the generation of data sets for each failure mode is varied for each data set to provide a different likelihood of that failure mode applying to each data set.

23. The computing system of claim 21, wherein the failure mode determining element is adapted to, for each failure mode, determine how each data set for that failure mode performs for that machine learning algorithm and to compare the performance of the test data to each of the data sets.

24. The computing system of claim 23, wherein the failure mode determining element is adapted to compare the performance of the test data to each of the data sets by establishing where the test data lies on a linear interpolation between a least effective data set and a threshold data set that substantially performs at the performance threshold, wherein the position of the test data on the linear interpolation is equated to a likelihood that the associated failure mode is responsible for machine learning failure.

25. The computing system of claim 16, wherein the output providing element is adapted to provide a listing of the failure modes in an order of likelihood that each failure mode is responsible for machine learning failure.

26. The computing system of claim 25, wherein the output providing element is also adapted to provide a remediation strategy for providing a machine learnable data set for the task.
